(19) United States
(12) Patent Application Publication
(10) Pub. No.: US 2006/0184867 A1
(43) Pub. Date: Aug. 17, 2006

(54) Method for reusing definitions in documents and monitoring thereof

(76) Inventor: Avraham Shpigel, Rishon Lezion (IL)

Correspondence Address: LAW OFFICES OF BRIAN S STEINBERGER, 101 BREVARD AVENUE, COCOA, FL, 32922, US

(21) Appl. No.: 11/355,849

(22) Filed: Feb. 16, 2006

Related U.S. Application Data
(60) Provisional application No. 60/653,506, filed on Feb. 17, 2005.
(60) Provisional application No. 60/740,288, filed on Nov. 29, 2005.

(51) Int. Cl. G06F 17/21; G06F 17/24; G06F 7/00

(52) U.S. Cl. 715/500; 715/511; 707/100

(57) ABSTRACT

A method for reusing, managing and monitoring definitions in documents. The new method suggests using a dedicated process that manages the ‘life cycle’ of the definitions called ‘the definition transitional states process’. This process keeps track of each definition version in a dedicated versions tree, state transition process and history/log files functioned to track the changes. The method further suggests a systematic way to monitor the process of updating all the relevant documents whenever a definition in one of the hierarchical documents is created or modified.

### CROSS-REFERENCE TO RELATED APPLICATIONS

This application is related to U.S. Provisional Patent Application 60/653,506 filed Feb. 17, 2005 and U.S. Provisional Patent Application 60/740,288 filed Nov. 29, 2005 and whose disclosure is incorporated herein in its entirety by reference.

### FIELD OF THE INVENTION

The present invention relates to a method for facilitating documents handling and more particularly to a method for reusing, managing and monitoring definitions in documents.

### BACKGROUND OF THE INVENTION

The use of predefined definitions in technical papers is considered critical for efficient and coherent writing. The concept of reusing said definitions is based on the presumption that once the definitions have been set forth they may be used and reused in many places in the original document as well as in many other documents and in other projects over a long period of time.

Definition, as will be defined in further details below, generally relates to any component or object that may serve as a reusable building block of documents and that is part of the dedicated conceptual environment of an organization.

The process of reusing definitions in large-scale organizations usually involves myriad of hierarchical documents trees, wherein low-level child documents are deriving from higher-level parent documents. These documents are not limited to and may be any of the following: standardization documents, marketing documents, requirements documents, SW/HW development documents, testing documents, integration documents, quality documents and customer related documents. In any type of document it is crucial that hierarchical documents be consistent with each other and that they all use the same definitions.

One of the fundamental aspects of reusing definitions is to enable users, (e.g. engineers) to change and modify the definitions they are using throughout the documentation life cycle. However, these changes and modifications should be monitored and managed under predefined rules and processes in accordance with the organization's requirements.

In the past there have been several attempts that have directed to methods and systems that address a certain degree of reusing definitions in technical documents. None address the overall problem.

Specifically, inventions in the prior art deal exclusively in textual terminology and not in any other form of definitions such as graphical figures, tables, communication standard protocols, different kinds of data, formulas and the like. Furthermore, inventions in the prior art do not offer any form of monitoring a definitions whole life cycle.

U.S. Pat. No. 6,098,034 discloses a method for automatic searching of phrases that may be considered as candidates for reuse. According to this reference, definitions from one document can be reused by other documents. This reference relates only to terminology, i.e. textual definitions only. It also lacks any monitoring functionality: phrase history, phrase state, phrase version and super user tools are not mentioned.

U.S. Pat. No. 5,060,154 discloses an even more limited scope than the former reference. This reference discloses a system that resembles a word processor speller wherein the user is provided with alternative words and phrases from a predefined list, corresponding to the word he or she has typed.

Organizations that undertake long-term projects (especially in the technology field) are often characterized in that throughout the life cycle of each project, definitions are constantly being changed and modified. For example, a certain communication message may change during a specific project to an advanced version. Another example is that in two parallel projects, a certain graphical figure has two versions, one for each project, according to each project's specifications.

Therefore, there is a long felt need in the documentation industry for a tool that enables tracking the versions development of each definition in each project and provides a full, thorough and updated snapshot of the definitions reuse in the organization at any time.

### SUMMARY OF THE INVENTION

The present invention discloses a method for reusing, managing and monitoring definitions in documents. The present invention suggests using a dedicated process that manages the ‘definition's life cycle’ of these definitions. This process is hereinafter referred to as ‘the definition transitional states process’ or simply ‘the process’.

The present invention employs a dedicated database, known as ‘the definitions database’.

Each definition is named and referred to by a specific notation known as a ‘title’. The title is directly linked to the definitions list and to the substance of the definition.

The process described in the present invention keeps track of each definition version in another dedicated database structure known as ‘the versions tree’.

In addition, the process described in the present invention further suggests a systematic way to monitor the process of updating all the relevant documents whenever a definition in any of the documents is created or modified or whenever an error is found.

Monitoring and management of the process described in the present invention is conducted by using super user tools functioned to examine and monitor the definition's life-cycle. In addition, these tools may send automatic (or semi automatic, according to the user's preferences) updating messages, e.g. by email, to the relevant users.

Another fundamental aspect of the present invention is the introduction of a ‘sections’ feature. This feature allows a user to create his or her own variation of a certain definition in what is known as a ‘section’.

The main advantage of the ‘section’ is that it does not further complicate the versions tree with additional version level. Rather, it enables using ready-to-use definitions in a slightly different presentation that is more convenient to the user. This feature may simplify the versions tree that may reach a complex and unmanageable size, particularly in large organizations dealing with long-term projects having multiple releases.

Similarly, the ‘section’ feature may be applied on the definition ‘titles’. Thus, a user may create a variant of a definition title for his or her own local use whenever a different presentation of the definition title is required (e.g. the use of passive instead of active voice).

It should be noted that whereas according to the present invention, when a rigid life cycle for definitions is set, users are encouraged to take part in this life-cycle. Users are provided with the freedom to create, modify and change definitions to their needs, as long as their activities are monitored by quality assurance personals in order to preserve compliance with the definitions life-cycle.

One of the tools suggested by the present invention is a log file that facilitates tracking the actions applied on each definition.

Another aspect of the invention relates to errors management. A dedicated process for the detection and correction of errors is presented. Additionally, the present invention deals with the need to update all the documents where error definition were found in two levels: 1) replacing the error definition 2) fixing the document part that uses the error definition.

Yet another aspect of the present invention is to provide the user as he or she writes, with appropriate candidates for definition from the definition's libraries. Specifically, the tool may search definitions according to predefined keywords from priorities libraries list using ‘wild card’ and linguistic methods for similar words. Specifically, each document is allocated to a list of hierarchical libraries, wherein the higher the library level, the higher the priority. Hence, upon searching a definition candidate, the definitions on the higher level libraries are prioritized.

Yet another aspect of the present invention is to provide mandatory reuse of definitions from a specific library. For example, to use in child documents all the definitions of a certain library that are used in the parent document.

The definition reuse method, in part or in full may be useful in other fields other then hardware and software development such as reuse definitions in low documents or in medical documents.

A systematic method encompassing all the above-mentioned goals in a well-defined process is presented below.

### BRIEF DESCRIPTION OF DRAWINGS

Further features of the present invention, as well as the structure and operation of various embodiments of the present invention, are described in details below with reference to the accompanying drawings:

FIG. 1 is a definition transitional states diagram;

FIG. 2 is showing the structure of the definition log file;

FIG. 3 is an example for a definition versions tree;

FIG. 3.1 is a more detailed example for a definition versions tree;

FIG. 4 is showing the document-level database structure;

FIG. 5 is showing the project-level database structure;

FIG. 6 is showing the database structure of the definitions section concept;

FIG. 7 is an example for using the definition section concept in two releases;

FIG. 8 is a transitional states diagram to fix the document part that uses an error definition;

FIG. 9 is a database structure that is needed to fix the document when errors in definitions are found; and

FIG. 10 is an example for scenario to handle an Error in a definition in multiple documents.

### DETAILED DESCRIPTION OF THE INVENTION

In the following description, numerous specific details are set forth to provide a more thorough understanding of the invention. However, it will be apparent to one of skill in the art that the invention may be practiced without one or more of these specific details. In other instances, well-known features have not been described in order to avoid obscuring the invention.

The present invention discloses a method for reusing, managing and monitoring definitions in documents. The present invention suggests using a dedicated process governing the ‘life cycle’ of the predefined definition, hereinafter related as ‘the definition transitional states process’.

In the following description, some terminology is used in general to describe certain features of the present invention as follows:

‘Definition’ is generally viewed as any object (e.g. any data or any description) that may serve as a building block of a document and that is part of the dedicated conceptual environment of an organization. This may include, but not limited to: technical terminology, terms defined by the user, non-textual figure, tables and objects, mathematic formulas, hardware and software component and their visual representations, communication messages and the like. It may be important to note that whereas definitions focus on objects, they may not include actions. In addition, there may be nested definitions as well, in which a certain definition may include another one within it. Definitions may also include instructions formats e.g. XML format that are used for automatic testing.

‘Definition title’, or ‘title’ corresponds to the definition and is used to name and relate it in the documents and the life cycle as a whole. This title may be linked to the description and or any content of the corresponding definition.

‘Keywords’ relate to a list of keywords manually extracted from a definition's description part or from the title and held in a dedicated database.

‘Document’ is generally defined as any written material, usually textual but not limited in that respect, created or used by users in an organization.

‘User’ is generally defined as any person authorized to write or modify any of the organization's documents, e.g. an engineer.

A ‘super user’ is a user with additional entitlements usually in the field of monitoring the process life cycle e.g. a quality assurance engineer.

‘Definition life-cycle’ relates to the different phases of the definitions, covering the creation of new definitions, their examination, and approval for use, modification, re-approval, monitoring and deletion thereof and part of the whole SW/HW development life-cycle process. In other words, the concept of life-cycle in organizations usually relates to the different stages in product development (may it be hardware or software, but also the pharmaceutical industry and any other industry). These stages include anything from the idea inception to product development, testing and marketing. The definition life cycle follows the above-mentioned organizational life-cycle.

‘Definition transitional states process’ or simply ‘the process’ lies at the heart of the invention and relates to the controlled process governing said life-cycle of definition according to the present invention.

‘Versions tree’ relates to the database structure that encompasses all the different versions of each definition.

‘Definition database’ relates to a dedicated data structure that includes all the information about definitions.

‘Log file’ relates to a file holding all the records indicating the previous definition statuses and actions performed on each definition.

The ‘definitions list’ represents all the definitions that are used in a certain document. Each definition is linked to the definitions libraries database and whenever a user selects and reuses a definition from the definitions libraries, the corresponding content of the definition description part is copied from the relevant library to the document definitions list. The reuse definition title may serve as a link to the said definitions list. Said list refers exclusively to a list of definitions being used in a certain document. If, for instance a new definition is created or an existing one is being reused, then said definition will be added to said list, and placed in an alphabetic order.

According to the preferred embodiment of the invention, the invention is a process that facilitates definitions handling and governing throughout their life-cycle.

Therefore it is possible to design and implement the invention in various ways and it is not technology dependent. The approach taken in the present invention is to simplify the interaction between the user and the tool based on the invention while taking into account existing software development life-cycle in the organizations.

According to one embodiment of the invention users are presented with appropriate definitions candidates automatically while editing. This may help the user to find more efficiently the closest definition available on the organization's database or alternatively lack thereof. One method that may be suitable for searching candidates according to the current invention is based on keyword search, Said keywords being terms that were allocated to the specific definition upon creation. For example, if while editing a single sentence (or paragraph) some or all of the keywords are matched then a kind of popup window will indicate to the user for possible existing reusable definition. Another option is introducing a search method that is syntax independent, where a search may yield any variation of the original keywords search independent of keywords syntax or tense or by using linguistic methods for searching similar words for the input keywords base on thesaurus synonyms.

According to another aspect of the invention, some of the actions performed by users on definition should be approved before they are ready for use. Follows are some of such actions:
Creating a new definition.
Modifying an existing definition.
Using a faulty definition version (version not according to the allocated prioritize libraries of a child document).
A ‘must reused’ definition that has never been used in a specific document.

According to one embodiment of the invention only some users are authorized to performed approval. These may be a super user or predefined users. The log file feature may help keep track with approval history as well.

According to one embodiment of the invention, the process of approving a definition can be as follows: a request for approval may begin by sending an email that contains a link to the specific approval page. The receiving person may approve the request or alternatively to forward the email to someone else to approve it (to a more professional person for example).

According to another embodiment of the invention the definitions transitional states process supports nested definitions which are definition title that appear in other definitions description part and makes all the logic connections required between them.

According to yet another embodiment of the invention, the definitions transitional states process will reject any attempt to use the same definition name. The definitions transitional states process will prompt the user when trying to create new definition with existing name.

According to yet another embodiment of the invention the present invention allows unique measurements that are very important for organizations that want to improve the process and the quality. These measurements supply the organization with qualitative and as well as quantitative information.

Following are several examples for such measurements. It should be important to note that these are merely examples for calculating said measurements that are basically aimed at getting a certain evaluation of the reusing process:
Quantity:
   a. The number of definitions in a specific document
   b. The average number of times that a specific definition is reused in a specific document
   c. The number of error definitions in a specific project or document
Efficiency: relates to the textual part of a definition. It may be calculated by the following way: one minus {the number of words in a documents, divided by the number of words the same document would have if the definitions titles were replaced each with the corresponding description}. In cased a definition from an external library is used, when counting the number of word in a document, the number of words in this definition's description should be subtracted. The efficiency can be calculated:
   a. In a specific doc
   b. In all the docs in a project or release
Consistency: the average reuse definition depth which is the number of child documents reusing the same definition in the project documents—higher number of children indicates higher consistency.
Complexity: the average number of branches of definition versions that do not derive directly from the main life-cycle of the definitions and documents of the project. Note: when using the section feature the complexity is minimal.

According to the preferred embodiment of the invention, this process will keep track of each definition versions and will further suggest a systematic way to monitor the process of updating all the relevant documents when a definition in one of the hierarchical files is created or modified or the case when error is found.

According to the preferred embodiment of the invention, the above-mentioned operations may be performed by using super user tools and/or sending manually or automatically updating messages (such as email) to the relevant users.

Preferably the invention and its application allow users to modify definitions. The fact that each such modification is monitored may facilitate the interplay between users, knowing that any change is logged and is governed under a rigid though modular process.

Preferably, as part of the monitoring process of quality assurance (QA) users, the current invention will enable them to perform certain queries regarding the definitions and their life cycle status. For instance, a query may ask to get all the unready documents for a specific project or get all the definitions in examination state for a specific project or get all the documents with ‘must reuse’ definitions but unused in a specific document, etc. Another important query relates to finding error definitions and tracing them to specific documents and users.

Preferably, unused or modified definitions in low-level documents may be allowed as long as they are monitored and documented in a dedicated history log file as explained below.

It may be important to note that the user interface can be implemented with menus-based and may be embedded as an adds-on tool on any word processor such as MS Word or requirements management tools as well e.g. menu to create or modify definition or menu for viewing log history file of a selected definition or menu for viewing version tree of a selected definition or menu to add definitions library to a document, etc. A menu can be added as part of the Word main menu under the ‘tools’ and/or using the mouse menu key directly on a selected definition.

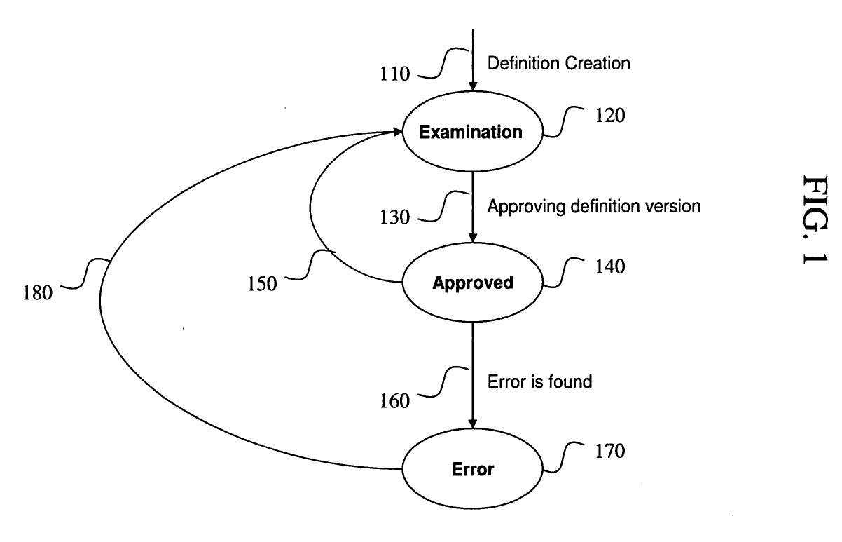

Referring to FIG. 1, definitions transitional states process is shown in accordance with the preferred embodiment of the present invention. The transition state diagram represents the case wherein a definition is created or modified or when an error is found. In the first step, a definition is created by a user 110. The definition then undergoes an examination process where its status is set to ‘examination’ 120. The definition is then undergoing an approving process 130, and when it is approved its status is set to ‘approved’ 140. At any point then, a user may modify the approved definition and create a new definition version 150. This modification 150 is then undergoing the examination status 120 and the approving 130 until its status is set again to ‘approved’ 140. Then at any time, an error can be found 160 in the approved definition 140 setting its new status to ‘error’ 170. Error definition 170 can be modified 180 to create new definition version 120.

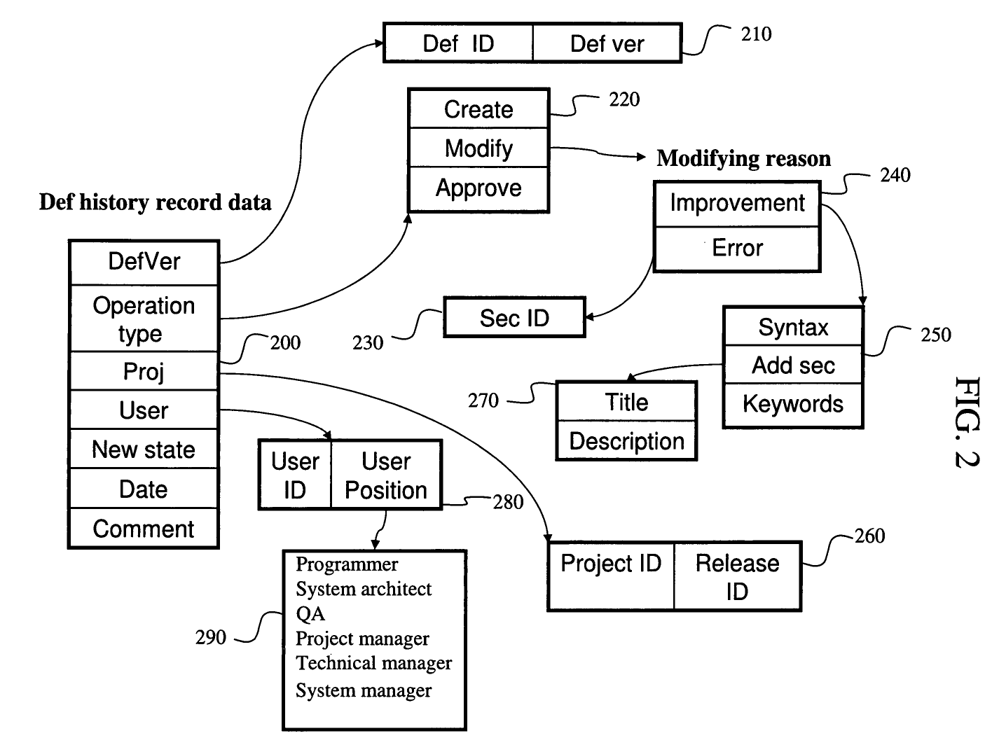

Referring now to FIG. 2, the structure of the definition log file is depicted in greater details for every new definition operation. The main data structure is the definition history record 200 that organizes all the data fields relating to record keeping. One such filed is the definition version 210 that includes information regarding the definition identification and the definition version. Another field is the operation type field 220 that may include the action or operation type such as create new definition, modify existing definition or any kind of approve. A sub field from the modify field in 220 is the modifying reason field 240 which may include the reason a definition was modified such as an improvement in a definition or when an error has been found. When the modifying reason 240 is error then sub field 230 contains the error section ID. The improvement field in 240 is further partitioned to improvement type sub field 250 which can be syntax, adding new section or modifying the keywords. The add section sub field 250 is further partitioned to the section addition sub field 270 which includes the definition section title and the definition section description. Going back to the definition history record database 200, the user field is partitioned to sub field 280 which includes a user identification and user's position in the organization 290 which includes a programmer, a system architect, a QA personal, and all others types of users and managers that are available in each organization. The project field in 200 further partitions to a project identity and release identity 260. Going back to the definition history record database 200 that contain the new definition state, the operation time and free comment that the user can add.

It may be important to note that not all components and fields of said data structure are being used in any action performed over a definition. Each action may use different components and fields. For example, when using ‘create’ 220 the ‘modify’ 240 is non relevant.

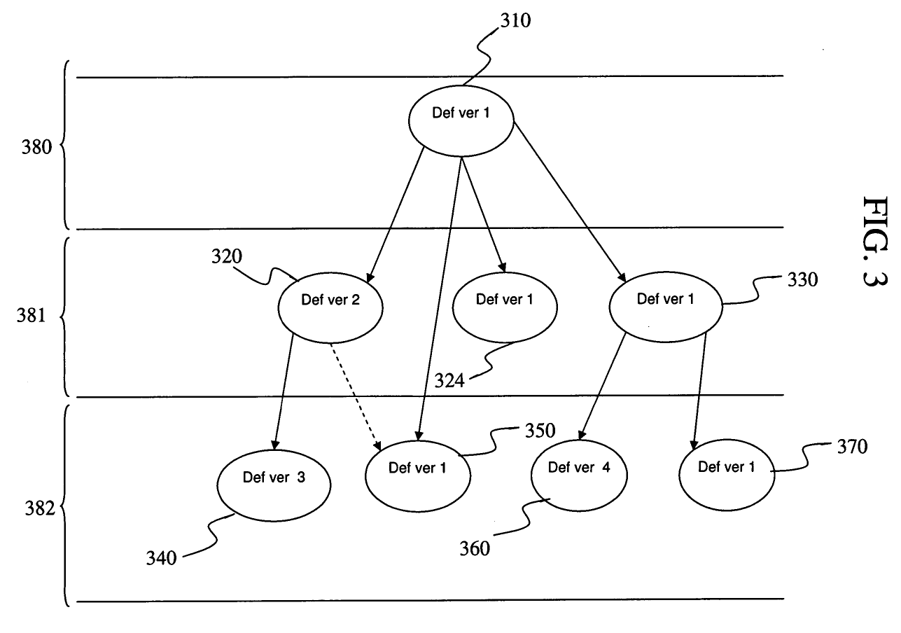

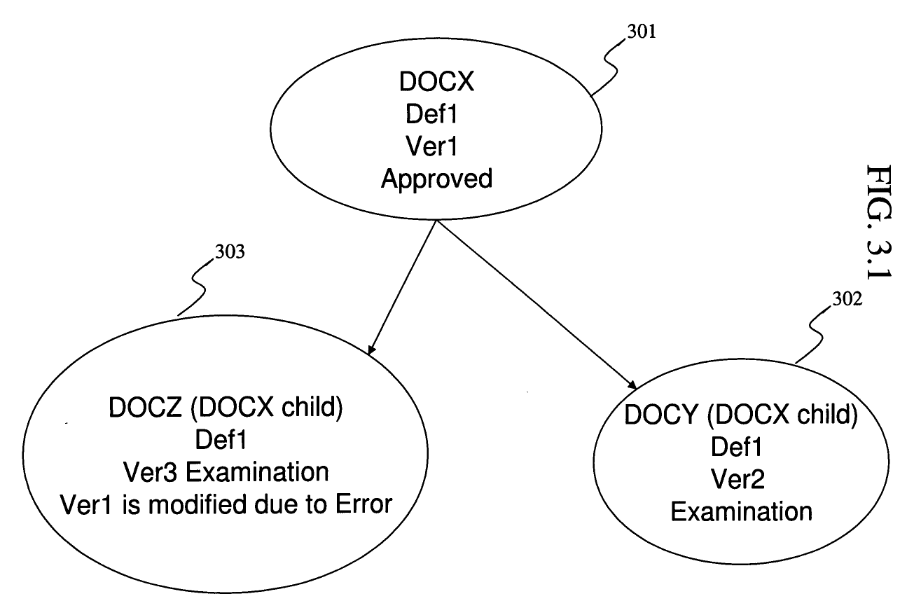

Referring now to FIG. 3, an example for versions tree of a single ‘definition’ (referred to in this figure as ‘Def’). This example demonstrates the flexibility of the reusing definition process at the heart of the present invention. This flexibility allows definition changes in any level of the hierarchical documents tree. Follows is a description of the interplay between parents and children documents and their possible derivative definitions versions. Depicted are three levels: The parent document level 380, the first generation children document level 381 and the second generation children document level 382.
The top parent 310 document uses definition version 1.
Children documents 324 and 330 reuses definition version 1 derived from their parent document 310 ‘as is’ without modifications.
Child document 320 uses definition version 2—a modified definition version 1 (adding some details for example).
Child document 340 uses definition version 3—a modified definition version 2.
Child document 350 reuses old predecessor parent 310 definition version 1 also its real ‘must reuse’ parent is 320 definition version 2.
Child document 360 uses definition version 4—a modified definition version 1.
Child document 370 reuses definition version 1 from its parent 330
It may be important to note that definition versions may serve not only in various documents of the same project but also as different versions on several projects as well e.g. data base changes in new project or release.

Referring now to FIG. 3.1, a detailed example for a versions tree of a single definition called ‘Def1’ for 3 documents DOCX 301 with next generation child documents DOCY 302 and DOCZ 303. Ver1, Ver2 and Ver3 in this figure relates to definition version 1,2 and 3. DOCX has an approved definition Ver1. In DOCY, definition Ver1 from DOCX was modified to definition Ver2 and now it is in examination state waiting for its approval. In DOCZ, an error is found in definition Ver1, the definition was modified to new definition Ver3 setting the modifying reason to ‘error’. The new definition Ver3 is in examination state waiting for its approval. Once the error is approved, all the documents that uses definition Ver1 and all its derived definitions (like Ver2) will be set to error state that must be fixed as described in details in FIG. 11.

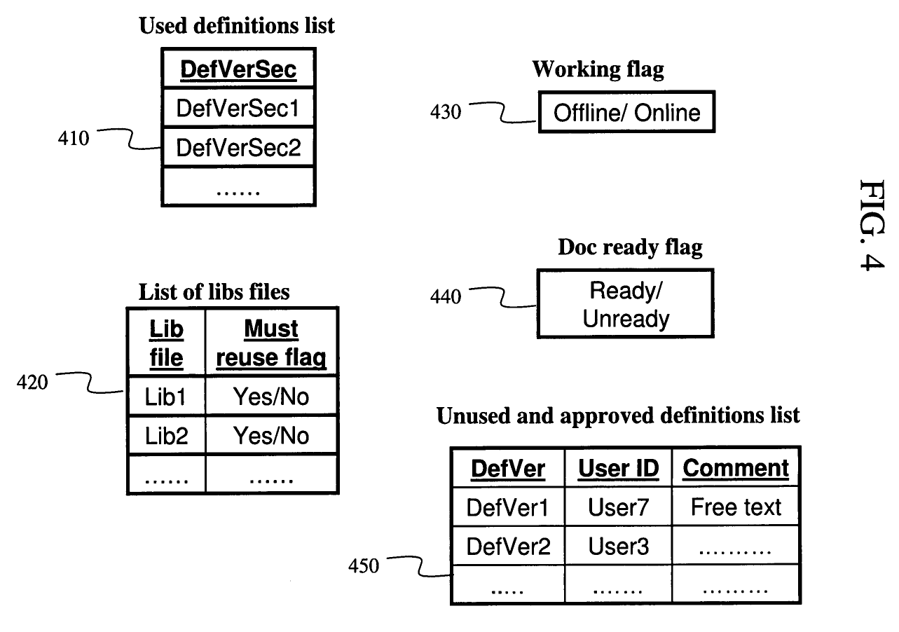

Referring now to FIG. 4, the database structure on the document level is presented in details. The list of all the definitions used in the specific document is presented in 410. Each definition in the list contains also the definition version and the section identity that is used in this document. Another data structure is the list of library files 420 with a corresponding flag noting whether a reuse of all the definitions from this library is mandatory or not. The libraries list order in 420 represents the priority level of each library. Another data is the working flag 430 which indicates whether the document is connected online to other users and thus transparent or whether the document is offline and the user may modify without other user seeing its changes as long as this flag is in offline. Another data relates to the case when reuse of definitions from a specific library 420 is a must. The unused definitions must be approved in definitions list table 450 showing each definition version and its corresponding user identification that approve the unused of this definition and any comments relating it. Another flag is the document ready flag 440, which indicate that all the definitions are accepted and approved, all the must reuse definitions are reused and the must reuse but unused are approved.

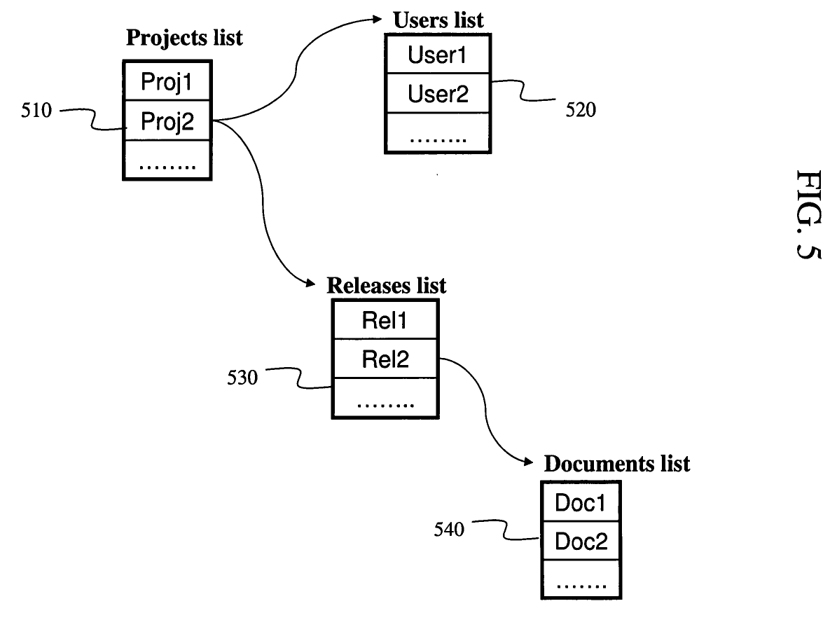

Referring now to FIG. 5, the database structure on the project level is presented in details. The project list database 510 provides a list of all the projects in the organization. Each project includes the users list 520 of all the users involved on the project. Each project includes also the releases list 530. Any release is further includes the documents list 540.

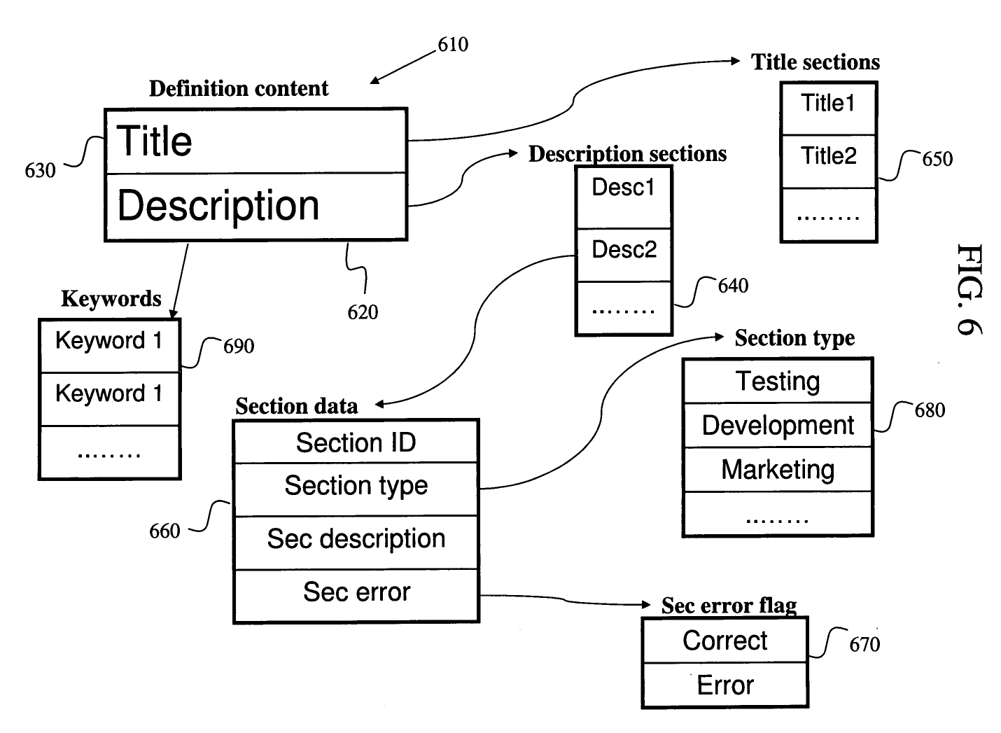

Referring now to FIG. 6, the concept of definitions ‘sections’ is presented in a form of a database structure. This feature allows a user to create his or her own variation of a definition in what is known as a ‘section’. It should be noted that when a new section is created under a new version of the definition it should too undergo a process of examination and approving.

The main advantage of the ‘section’ is that it does not further complicate the definition versions tree with additional versions branches. Rather, it enables using ready-to-use definitions in a slightly different presentation that can be more convenient to a specific user. This feature may simplify the versions tree that may reach an unmanageable size, particularly in large organizations dealing with long-term projects. Different formats e.g. XML can be occupied in a dedicated section. It is assumed that a kind of unifying sections will be performed in every new project or release.

The definition content data structure 610 includes a title field 630 and a description field 620. The title field 630 is the definition reuse indication or notation in the document whereas the description 620 is the content of the definition. The definition data structure 610 is also connected to the keywords list 690 which included all the predefined lists of keywords set by the user during the creation or modified later based upon corresponding definition's title and description. The title field is linked to the titles sections field 650 which includes all the variations of the specific titles—these variations may be synonyms and or different syntax such as passive or active voice notation. Similarly, the description field 620 is linked to the descriptions sections 640 which include all the variations of the definition description. These variations may include slightly different description that is more convenient for some users or additional more (or less) detailed information. Each description variation on the description sections list 640 is further linked to a section data structure 660 that includes data on each variant of the description section, such as; section identification, section type, the section description content and a possible error indication for this section. Each section type on the section data 660 can be further classified into sections type 680 such as testing, development, marketing and the likened. Finally, the section error field on the section data 660 is further classified into section error flag 670 which indicated whether the specific section definition is correct or error.

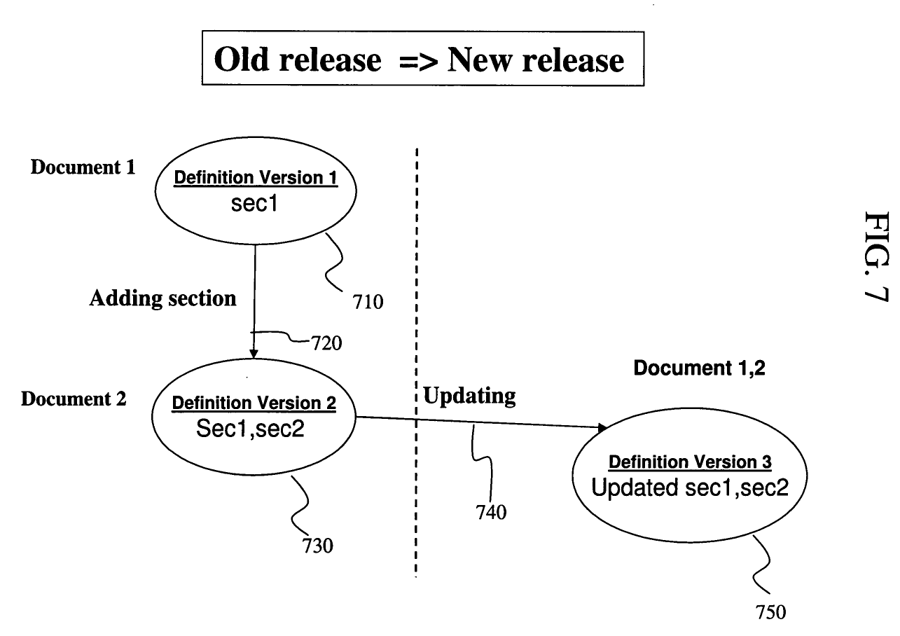

Referring now to FIG. 7, an example of how the ‘sections’ concept explained above may simplify the definition versions tree reuse process, whereas ‘release’ indicates a new version of a project following a possible definitions changes.

In the Old release:
Document 1 710 uses definition version 1 that contains a single section called Sec1.
Document 2 730 needs some modification (e.g. adding some details) and so definition version 1 is modified 720 into definition version 2 by adding new section—Sec2. In this stage definition version 2 contains two sections Sec1 and Sec2. As explained above, the section feature enables users to create a definition variant whenever needed without complicating the versions tree.
The new definition version 2 undergoes the examination process like any other definition changes.

In The New release:
A new release may require updating the definition Sec1 and Sec2 because of e.g. changes in the standard.
Sec1 and Sec2 in documents 1 and 2 750 are updated from only one branch 740 to definition version 3 750. Here lies the major advantage of the ‘sections’ feature—the updating is performed on the cluster of sections (here section 1 and 2) over only one branch. If the sections feature was not in use, a possible different branch for each definition version should have been required. Taking into account that a definition versions tree can contain multiple branches, it may be very complicate to decide from which branch to do the reuse in the new release (take also into account that the time between different releases of a specific feature can be sometimes very long).

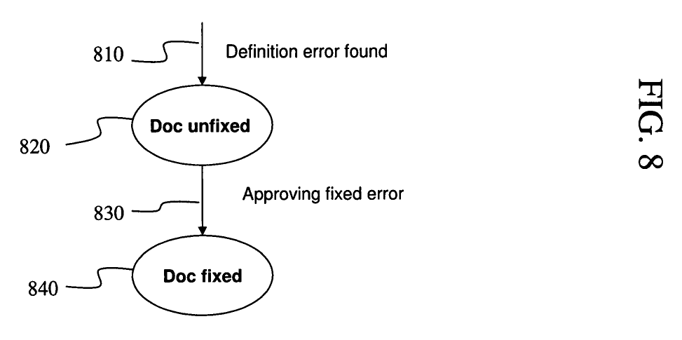

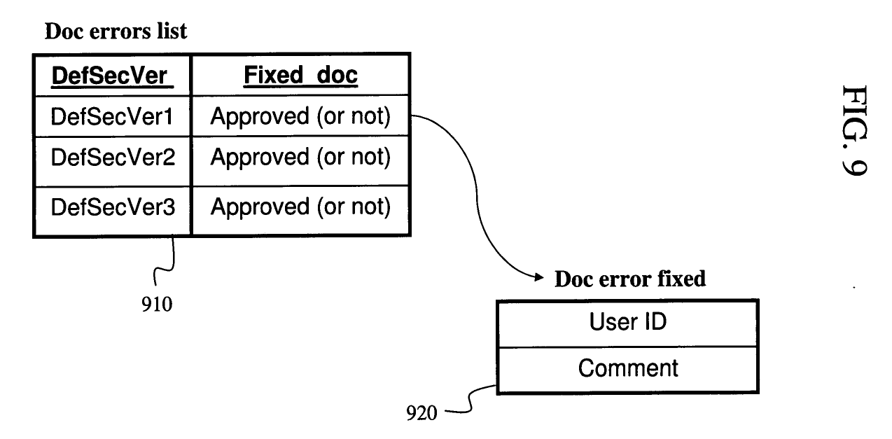

Referring now to FIG. 8 and FIG. 9, a transitional state process dealing with the case when a definition error is found and the document that uses it should also be fixed. In the first step, a definition error has been found 810 and approved. As a result any document that uses this error definition its document status for this definition is set to document unfixed 820. The fixing of the definition part is described in FIG. 1 when a new definition version is created and approved. Subsequently the error in the document part that reuses this specific error definition is also fixed (if required) and approved by the authorized user 830. Finally, from the specific error definition point of view the document is fixed and the status is set to document fixed 840. The handling of definitions errors in the document level is gathered in the database structure as described in FIG. 9. The list of error definitions is presented in 910 where the DefSecVer represents the identity of the specific error definition, its version and the specific section. Each definition contains a flag that indicate if the document part is fixed for this definition (or not). If the document part is fixed for this definition and approved, its user ID and the approving comment is presented in the document error fixed database structure 920.

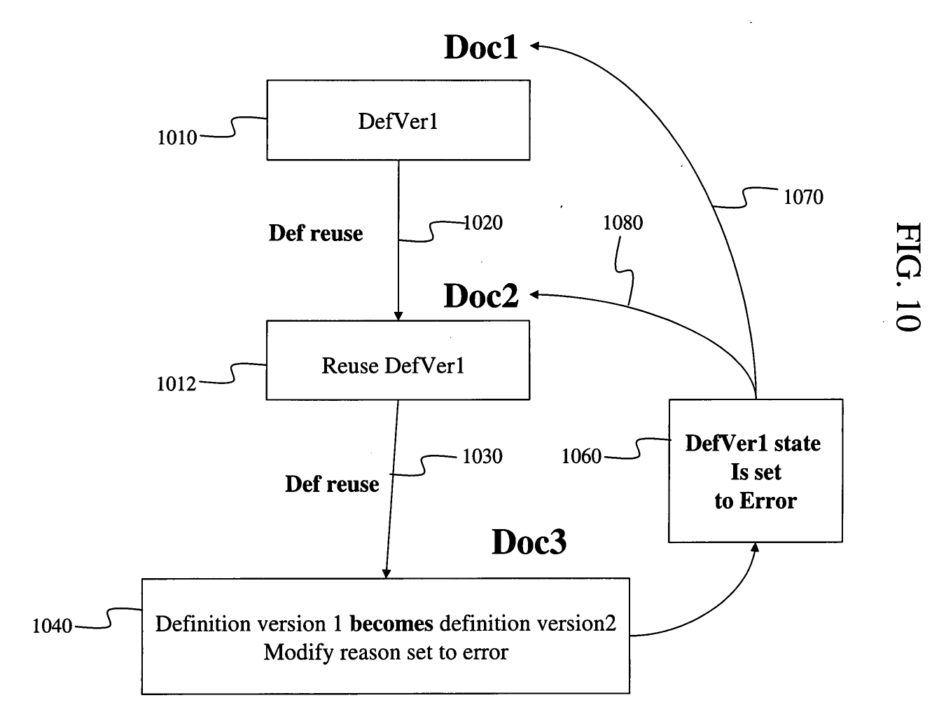

Referring now to FIG. 10, an example for handling a definition error life cycle. Note: in this example the definition has only one section to simplify the explanation. According to this example, document 1 1010 uses definition version 1. Document 2 1012 reuses definition version 1 from document 1 1010, ‘as is’ without any changes 1020. While editing definition version 2 1040, an error is found in the reused definition version 1. Definition version 1 is modified to definition version 2 to fix the error setting the modifying reason flag to Error. When definition version 2 1040 is approved and ready the QA user receives an automatic message that definition version 1 was modified because of error. The QA user changes the state of definition version 1 to error manually 1060 (it can be also automatically) and updates document 2 1080 and document 1 1070. When opening any document (such as document 1 1010) that uses definition version 1, the displayed definition will show the error state: def_{ver1, error.} Emails are sent to all the relevant users to fix the error in document 1 1010, and document 2 1012. In order to fix the error, document 1 1010 and document 2 1012 users must replace definition version 1 with error free definition (reuse existing and approved definition or modify and approve the existing error definition). At that point the document update is taking place as explained above in FIG. 8 and FIG. 9. Finally, The QA user may continue to monitor the fixing process by using queries.

Referring now to Appendix 1, an example for real-life definition reuse is attached. This example is a communication message taken from the TETRA standard that holds many requirements, specifications, textual descriptions as well as tables. It holds information beyond relevance of the present invention, but it illustrates the following aspects in the context of the present invention:

Nested definition—‘TEMTA-SDS DELETE MESSAGES REQ PDU’ represents a complete TETRA message that can be used as a ‘definition’ candidate in this invention. Its subfields ‘Number of messages’, ‘PDU type’ and ‘SDS type’ can be a used as nested definitions candidates in the ‘TEMTA-SDS DELETE MESSAGES REQ PDU’ definition.

Error—as this message has many numbers relating to quantitative aspects (e.g. ‘SDS type’ can get only values 0-4) it may be clear that fundamental errors (e.g. ‘SDS type’ can get different values 0-2) may occur. Once such error is traced, the process described above may take place and handle the fixing and updating thereof.

Sections—clearly every engineer may want to use this piece of data in the relevant notation or variation (e.g. adding more information to the general description part or using different table format or presenting it in XML format in behalf of the testing group, using different title, etc). Thus ready made sections of this definition may be prepared in advance for the use of development engineers, integration engineers, testing engineers and QA personals.

What is claimed is:

1. A method for definitions reuse in documents, wherein the documents have common context relating to at least one project, said method comprising the steps of:
(a) enabling a user to set a definition for the use in at least one document;
(b) keeping track of said definition's qualitative and quantitative parameters along the life cycle of said definition relating to at least one project.

2. The method according to claim 1, wherein said definition comprises a title and a description corresponding to said title.

3. The method according to claim 1, wherein the definition is any component of a document that may be a part of the conceptual world of an organization.

4. The method according to claim 1, wherein the definition may be any of the following: data, table, text, equation, figure, picture, any combination and formats and any component that may be reused.

5. The method according to claim 1, wherein said life cycle of said definitions in step (b) may include at least one of the following: definition creation, examination, approving, reusing and modification thereof.

6. The method according to claim 1, wherein step (b) further comprises enabling said user to modify said definition.

7. The method according to claim 1, wherein said document is linked to a list of at least one library, and wherein said library contains at least one definition that must be reused in said document.

8. The method according to claim 1, wherein said document is linked to a list containing all the definitions used in said document with their corresponding data.

9. The method according to claim 8,wherein said list is updated as soon as a new definition is used in said document.

10. The method according to claim 1, wherein step (b) further comprises monitoring error definition by updating all the documents containing said error definition.

11. The method according to claim 1, wherein step (b) further comprises monitoring error definition by enabling users to perform any of the following actions regarding said error definition: modifying and approving.

12. The method according to claim 1, wherein step (b) further comprises monitoring error definition by automatically sending a message to each user using said error definition.

13. The method according to claim 1, wherein step (b) further comprises allowing a user to set a definition to an error status wherein said status is automatically being updated in all definitions related documents.

14. The method according to claim 1, wherein step (b) further comprises presenting the definition title to the user in a graphically distinctive manner, providing information regarding at least one parameter relating to said definition.

15. The method according to claim 1, wherein step (b) further comprises notifying said user of any change in any definition's parameters.

16. The method according to claim 1, wherein said keeping track in step (b) is performed in real-time and a user that is linked electronically may see any changes made on definition's data as they happen.

17. The method according to claim 1, wherein step (b) further comprises enabling the user to work offline, wherein the user's changes when working offline are not seen by external users.

18. The method according to claim 1, wherein step (b) further comprises enabling a super user to approve a change made to a definition and wherein said change may be in any part of the definition's life cycle database.

19. The method according to claim 1, wherein the method operate within the scope of at least one of the following databases:
a. A database on the definition level;
b. a database on the document level; and
c. a database on the project level.

20. The method according to claim 1, wherein said keeping track in step (b) is done by holding the history information for any definition in a dedicated log file, and wherein any action performed on any definition is recorded on said log file.

21. The method according to claim 1, wherein said keep tracking in step (b) is done by building a versions tree data structure and wherein said versions tree contains information regarding each version and links between each version to another.

22. The method according to claim 1, wherein said keep tracking in step (b) further allows a user to define a section definition and wherein a section definition is a variant of definition.

23. The method according to claim 1, wherein the user is provided with tools monitoring the usage of said definitions along their life cycle.

24. The method according to claim 23, wherein said tools may include tools for searching appropriate candidates for definitions.

25. The method according to claim 23, wherein said tools may include tools for performing queries relating to definitions and their life cycle.

26. The method according to claim 23, wherein the user is a super user, and wherein a super user is a user who is entitled to performs activities beyond the user's entitlements.

27. The method according to claim 23, wherein said tools may include measuring of at least one parameter relating to a definition.

28. The method according to claim 27, wherein said parameter is the number of occurrences of said definition in a document.

29. The method according to claim 27, wherein said parameter is the writing efficiency, and wherein said efficiency relates to the ratio between the number of words in said document containing at least one reused definition and the number of words in a document wherein the said definition's title is replaced with the corresponding definition's description.

30. The method according to claim 27, wherein said parameter is the writing consistency, and wherein said consistency relates to the number of documents reusing the same definition in said project.

31. The method according to claim 27, wherein said parameter is the writing complexity, and wherein said complexity relates to the number of versions of said definition that do not derive directly from main definition and document life-cycle.
